(19) United States
(12) Patent Application Publication
(10) Pub. No.: US 2006/0271926 A1
(43) Pub. Date: Nov. 30, 2006

(54) Split download for electronic software downloads

(75) Inventors: York R. Hutton, Redmond, WA (US); Christopher S. Blackley, Redmond, WA (US); Ajay Sikka, Issaquah, WA (US); Danial G. Neault, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/246,512

(22) Filed: Oct. 7, 2005

Related U.S. Application Data
(60) Provisional application No. 60/686,368, filed on May 31, 2005.

(51) Int. Cl. G06F 9/44

(52) U.S. Cl. 717/168

(57) ABSTRACT

Systems and methods for a split download of Electronic Software Download (ESD), in a component based framework via employing a download distribution engine. The download distribution engine enables an independent software vendor (ISV) to download a respective portion of an associated software and/or digital content to a user, while a second ISV can supply another portion of the software and/or digital content.

### BACKGROUND

Increasing advances in computer technology (e.g., microprocessor speed, memory capacity, data transfer bandwidth, software functionality, and the like) have generally contributed to enhanced computer application in various industries. Ever more powerful server systems, which are often configured as an array of servers, are commonly provided to service requests originating from external sources such as the World Wide Web, for example.

As software systems have become more complicated, it has become common to down load and build such systems from a plurality of objects and files. For example, a software system may include hundreds of files or objects, wherein building software or application system(s) can be undertaken on one or more build machines, and downloads to an intermediate storage facility. Such build machines and download processes can compile, assemble, link, and/or interpret files or objects, for example. Typically, object-oriented computing is based upon the object model, wherein pieces of code called “objects” contain data (e.g., attributes) and may have actions (e.g., operations) performed thereon. An object can be defined by its interface, wherein the interface defines the characteristics and behavior of a kind of object, including the operations that can be performed on objects of that interface and the parameters to each operation. A specific instance of an object is identified within a distributed object system by a unique identifier called an object reference.

Many of the requisite files in the completed software product can be built in various stages, thus requiring a plurality of sources and/or generated/built files. Files generated by one part of the build process can be required as inputs to one or more other parts of the build process, and the build machines can have complete copies of the source files. For example, if a build machine A generates a file A1, and a build machine B generates a file B2, build machine A may need file B1 to produce a file A2, and build machine B may need file A1 to produce file B2.

In distributed object system, a client can also create a proxy that images an object on a server. Typically, a proxy is an image of an object where the object resides in a different logical and/or physical entity (e.g., machine, process, network, and the like.) In distributed systems, proxies can facilitate local processing to improve efficiency. The object that is imaged can implement a first set of one or more interface and base class data types. Moreover, such objects can require that a proxy load a first set of one or more attributes and/or methods to image the object. When the proxy is created for the object that is imaged, the interface and base data types implemented by the object are typically automatically loaded into the client.

Distributing files necessary to complete the build of the software system to the build machines involved in the build is network bandwidth intensive, requiring large transfers of information, some of which can become corrupted or even unavailable during an up load. For example, one build machine can only need ten files to complete its portion of the build, while another build machine can need two hundred files to complete its portion of the build, and yet one missing file or object can hinder a proper operation of a requisite application, for example by failing to properly load during a read, validation or execution.

At the same time, downloads from a plurality of independent software vendors may be required for a proper operation of an application or program. Such can create inefficiencies in streamlining development and deployment of the downloaded software. For example, certification and market delivery process can be adversely affected. Moreover, from a business policy standpoint, a software vendor may desire to supply its software directly to an end user, without another software vendor gaining access thereto. Also, licensing restrictions may exist on electronic distribution of such software. Additionally, software developers will not distribute their works to platforms they consider “potentially hostile,” e.g., when there exists possibility for fraud, wherein no guarantee is available that a license is issued to an authorized device.

Therefore, there is a need to overcome the aforementioned exemplary deficiencies associated with conventional systems and devices.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention provides for a split download of Electronic Software Download (ESD) in a component based framework, via employing a download distribution engine that enables each independent software vendor (ISV) to download a respective portion of its software and/or digital content to a user. As such, the download distribution engine can supply data exchange between a first ISV and a second ISV, to supply information such as: portions of the software that are to be downloaded to a user from each ISV, any additional or supplemental component that the user still requires to download for a proper run of the software, license requirements, billing procedures and the like. It is to be appreciated that even though the description herein is primarily explained in a context for an interaction between the first ISV and the second ISV, the subject invention is not so limited and can be implemented as part of three or more ISVs. In addition, in some aspects of the subject invention the first ISV can be the same entity as the second ISV.

In a related aspect, the download distribution engine can further include a monitoring component to observe the download of software and/or digital content from the first ISV to the user, and provide a process to install the remaining software components from the second ISV to the user. For example, upon initiation of download from the first ISV, a token can be passed to the second ISV in the background to provide download information (e.g., identification, billing, licensing requirement, versioning, authentication, security, access rights, digital rights management, and the like), wherein the second ISV can be prompted to supply the proper version of the software to be down loaded (e.g., for a particular geography, language, and the like). Thus, the customer/end user can enjoy a seamless experience when downloading the software. Such download from the first ISV and the second ISV can occur concurrently or at predetermined intervals, or be deferred to a later time with reminder notices sent to the customer/end user. Moreover, interrupt capabilities can be enable as part of the down load split, wherein a state of down loads can be logged and/or tracked based on a user request.

According to a further aspect of the subject invention, the download distribution engine of the subject invention can include a detector component, which detects a missing portion of the software that needs to be downloaded from the first or second ISV, and a notification component that notifies a user where to download the missing portion and/or obtain additional information about resolving problems associated with the missing portion of the downloaded software, for a supplement thereof. Such can typically assure proper validation and/or execution of a software (or digital content) downloaded by the end user.

Accordingly, in component driven architectures wherein a product can be built from a plurality of smaller pieces, such as packages that contain a group of functionalities, the download distribution engine of the subject invention can facilitate the download process, while mitigating problems with licensing and security issues. As such, each ISV can maintain requisite control over its software distribution. Moreover, recalls, patches and the like can be readily provided by the proper ISV for the respective download. Additionally, a distribution of bundled licenses can occur, wherein digital right management tokens can be conveyed to users.

In another aspect, a system for purchasing and distributing software using split download is provided. The system includes multiple ISVs, a merchant of record and a download manager. Each ISV is configured to provide a portion of downloadable software where each portion is provided by a separate ISV. The merchant of record is configured to handle an order for the downloadable software from a customer. The merchant of record is also configured to generate a transaction associated with the order and to provide the transaction to the ISVs. The download manager is a client component in the customer's device. The download manager is configured to download portions of the software from the ISVs and to build the complete software from the downloaded portions.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of a download distribution engine in accordance with an aspect of the subject invention.

FIG. 2 illustrates a schematic block diagram of a component based environment with a download distribution engine in accordance with an aspect of the subject invention.

FIG. 3 illustrates an exemplary download distribution engine in accordance with an exemplary aspect of the subject invention.

FIG. 4 illustrates a detailed block diagram of a distribution resolver that can supply information about the missing parts of a downloaded software/digital content according to a particular aspect of the subject invention.

FIG. 5 illustrates a general block diagram of a monitoring system as part of the download distribution engine in accordance with a further aspect of the subject invention.

FIGS. 6a & 6b illustrate arrangements of a first ISV and a second ISV, in relation to customers, and/or end user machines, according to a particular aspect of the subject invention.

FIG. 7 illustrates an exemplary sequence of query steps between a first ISV and a second ISV in accordance with an aspect of the subject invention.

FIG. 8 illustrates an exemplary architecture for an ISV that can split download according to a particular aspect of the subject invention.

FIG. 9 illustrates an exemplary methodology of splitting a software/digital content down load to an end user between a first ISV and a second ISV.

FIG. 10 illustrates a brief, general description of a suitable computing environment wherein the various aspects of the subject invention can be implemented.

FIG. 11 illustrates a client—server system that can employ a download distribution engine according to one aspect of the present invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

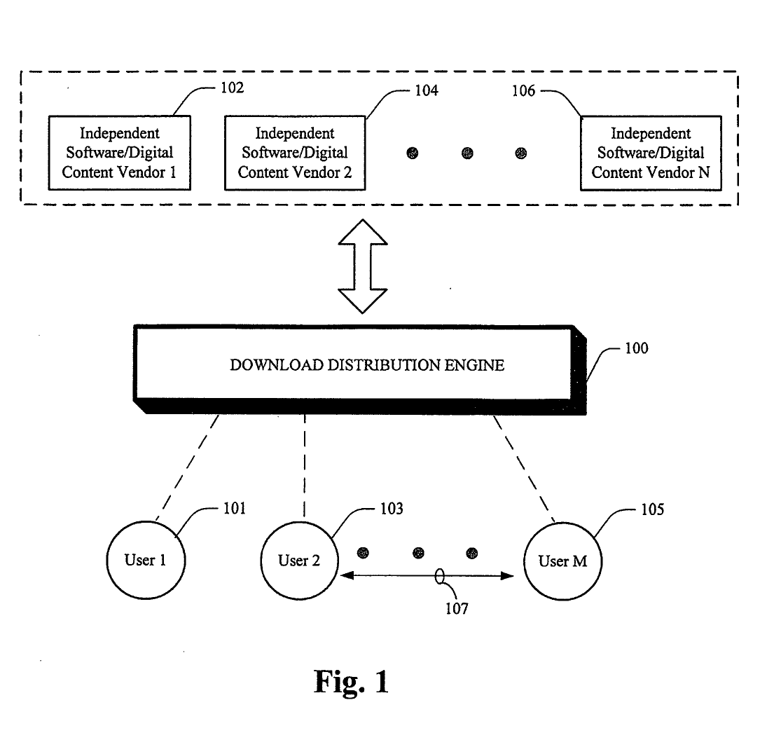

Referring initially to FIG. 1, there is illustrated a schematic block diagram of a download distribution engine in accordance with an aspect of the invention. Such download distribution engine 100 enables N independent software/digital content vendor(s) (ISV) 102, 104, 106 (where N is an integer) to download a respective portion of its software and/or digital content to M end user(s) 101, 103, and 105, (M is an integer.) Such end users can include devices such as palm pilots, personal digital assistants, media players, television sets, computers, and the like.

In additions, the end user(s) 101, 103, 105 can be part of a network system 107 that can be a system area network or other type of network, and can include several hosts, (not shown), which may be personal computers, servers or other types of computers. Such host generally can be capable of running or executing one or more application-level (or user-level) programs, as well as initiating an I/O request (e.g., I/O reads or writes). In addition, the network system 107 can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters.

Moreover, the network system 107 can be, for example, an Ethernet LAN, a token ring LAN, or other LAN, or Wide Area Network (WAN). Also, the network system 107 can include hardwired and/or optical and/or wireless connection paths. As will be explained in detail infra, the download distribution engine 100 can supply data exchange between the ISV 102, 104, 106, to supply information such as: portions of the software that are to be downloaded to a user from each ISV, any additional component that the user still requires to properly run the software, licensing requirements, billing and the like.

As will be discussed in greater detail below, downloading of software bundles can be split to afford software providers greater efficiencies and control over their respective products. A single ISV no longer needs to bundle all software associated with its respective product and distribute such software bundle to customers. Software bundles can now be split and electronically distributed to end users by disparate entities (e.g., actual producers of the respective software). By splitting a software bundle, second portions of a software bundle associated with a first software product ISV can be independently provided to the end user directly by the manufacturer of the second portions. Doing so provides the manufacturer of the second software greater control (e.g., distribution, manner of distribution, installation, maintenance, versioning, licensing, security, etc.) over the product.

Various scenarios will be discussed in greater detail for such distribution of software including for example: (1) while or after software is downloaded from a first ISV, a second ISV is prompted to download to the end-user its respective software associated with the software of the first ISV—such prompting can occur directly from the end user or even the first ISV; (2) the second ISV can also use the first ISV as a proxy for the downloading of its software, or alternatively serve as the proxy for the first ISV and its respective software; (3) the second ISV can also employ digital rights management and download multiple licenses for its respective software to the end user; (4) after initial downloading, the second ISV can moderate version control with respect to its software as well as staying concurrent and compatible with the software of the first ISV and end user's other software/hardware; (5) the distribution of the software can be performed over the hardwire as well as wirelessly and employ any suitable transfer medium as well as communications protocol available to effect such electronic distribution; (6) although full electronic distribution is expected to be most typical, it is appreciated that the distribution can also be bifurcated (if desired) such that certain portions of the software are electronically distributed and other portions physically distributed; (7) authentication, security, and digital rights management schemes can be employed to effect and facilitate electronic distribution of the respective portions of the software bundle. The foregoing scenarios and more will be discussed herein and/or readily apparent from the teachings of this document and all such implementations are intended to fall within the scope of the hereto appended claims.

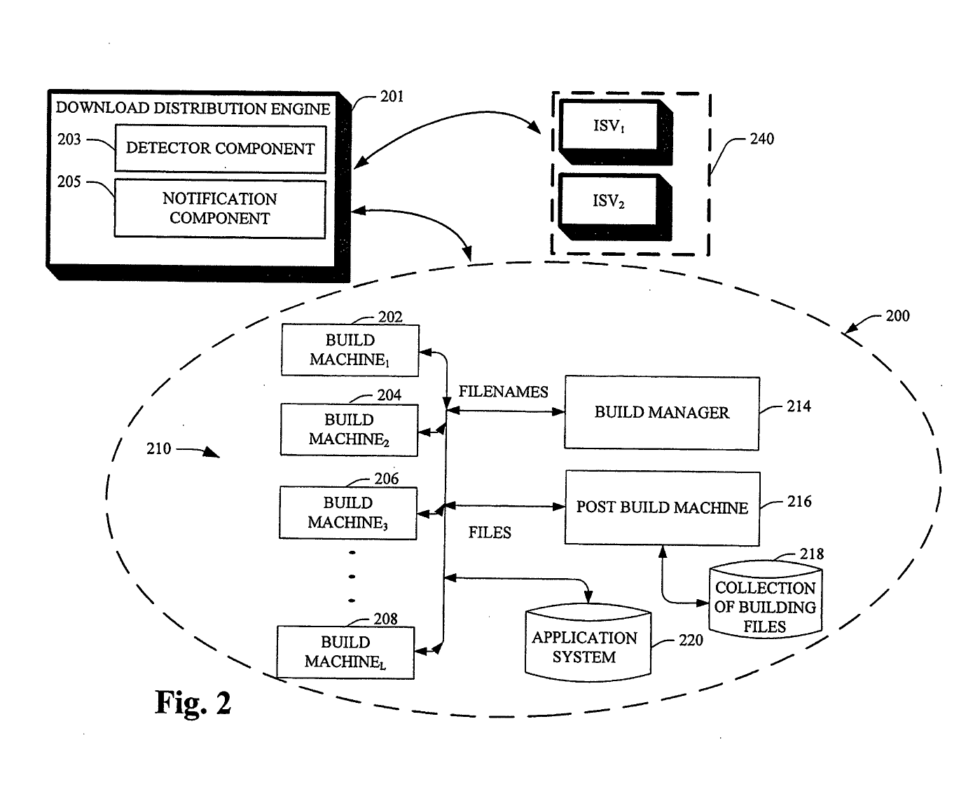

Referring initially to FIG. 2, there is illustrated a download distribution engine 201 that can facilitate building an application from packets (e.g., a group of functionalities) down loaded from ISVs 240, by employing a detector component 203 that detects a missing part of a downloaded software and/or digital content, and a notification component 205 that notifies a user where to obtain the missing object(s) and/or obtain additional information about resolving problems associated with the missing part. As such, during downloading software from a first ISV the download distribution engine 201 can detect any missing part(s) of such software bundle, and enable a user to download the missing part from a second ISV, and/or supply information about how to resolve issues related to proper download and execution of the missing portions from the second ISV.

As illustrated, the system 200 can manage the distribution and collection of downloaded packets and/or files involved in building an application system 220. Moreover, in such component driven architecture environment, typically components can be referred to as a specific piece of functionality that can be accessed through a contractually specified interface. Such components can be self-contained and clearly identifiable artifacts that describe and/or perform specific functions. For example, basic capabilities of the component based system 200 can include interoperability across networks, portability on different hardware or software platforms, and ability of self-managing data resources.

The system 200 can include a plurality of build machines 202, 204, 206, 208 (1 thru L, where L is an integer) collectively referred to as the build machines 210. It is to be appreciated by one skilled in the art that the build machine 210 can be physical machines (e.g. one or more computers), and/or virtual machines (e.g. one or more processes running on one or more computers). The build machine 210 can produce one or more build files employed in the application system 220.

The build machines 210 can compile, assemble, interpret, and/or link one or more source files into one or more build files. As one segment of the build machine 210 builds one or more build files, another segment of the build machine 210 can compile lists of the names of those build files that are published. For example, a published file can be one which is listed as a published file in one or more make files associated with the software system or application 220 being downloaded from the ISVs 240 and built from such download. The build machine 210 can then transmit the lists of build file names to a build manager 214. One segment of the build machines can also be designated as a post build machine 216, wherein the build manager 214 can then determine, for each segment of the build machines a list containing a subset of names of build files that the build machine 210 should transmit to the post build machine 216, which creates a collection or set 218 of build files. The build manager 214 can also determine, for each segment of the build machine 210, a list containing a subset of the names of files that the build machine 210 should receive back from the post build machine 216. Once the lists of the names of the files to transmit to, and receive from, the post build machine 216 have been distributed to the build machines 210, the files can be transferred to and from the post build machine 216. The file transfers can be initiated, for example, by a segment of the build machine 210, the build manager 214, the post build machine 216, or another process. The system 200 can undergo one or more stages of the processes described above to complete building the application system 220 on a user's machine. At one or more stages, the system 200 can wait for the build machines 210 to complete their building and copying to the post build machine 216 before initiating acquiring files from the post build machine 216. It is to be appreciated that although the build manager 214, and the post build machine 216, are illustrated independently, the processes executed by the build manager 214, and/or the post build machine 216, can execute on the same physical and/or virtual machine or machines. To properly execute the application system 220 when encountering a missing portion of downloaded software, the download distribution engine 201 employs a detector component 203 that upon uploading packets on a machine, detect any missing part, and subsequently a user is enabled to download the missing part from the appropriate ISV, or obtain information about how to resolve the issue, via the notification component 205.

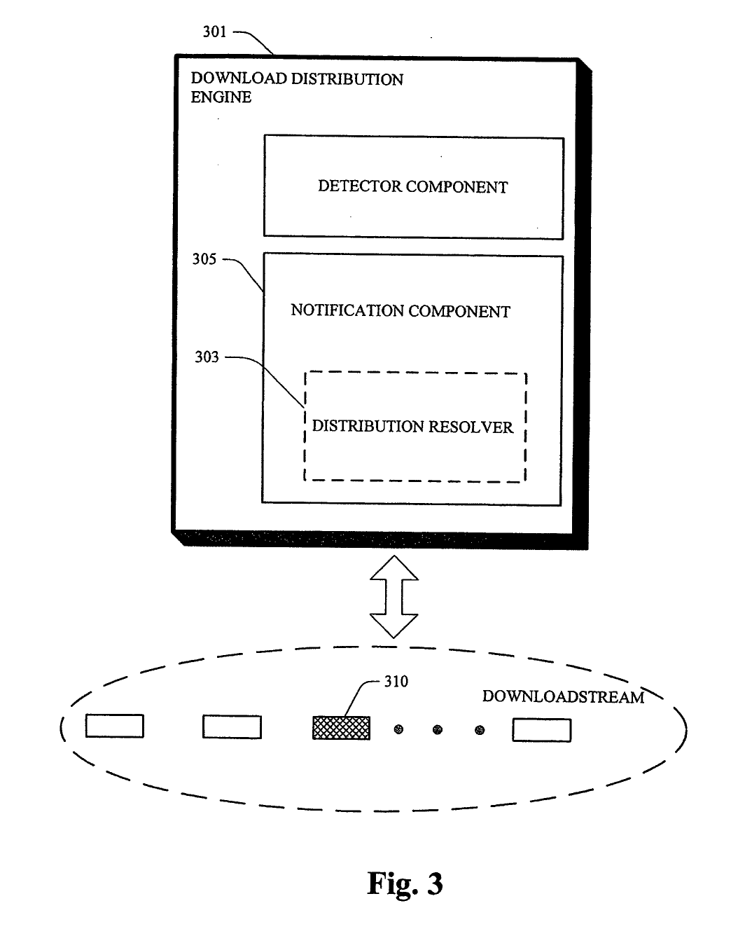

FIG. 3 illustrates an exemplary download distribution engine 301 in accordance with an exemplary aspect of the subject invention, wherein a distribution resolver 303 operates as part of the notification component 305. The download distribution engine 301 operates in a distributed object system, wherein a packet objects 310 can be downloaded as part of a software download from an ISV. Upon downloading a respective part of an application from an ISV to a user's machine, then the distribution resolver 303 can facilitate supplying a missing portion of the application by providing contact information about the particular ISV that needs to be contacted for a proper download of the missing portion of the application, to ensure a proper run thereof. The distribution resolver 303 can determine which of the components are missing of a download from a first ISV, and which need to be obtained from a second ISV. Such items can be retrieved and stored persistently, wherein the distribution resolver 303 can undergo one or more iterations of the processes described above, to complete downloading the application.

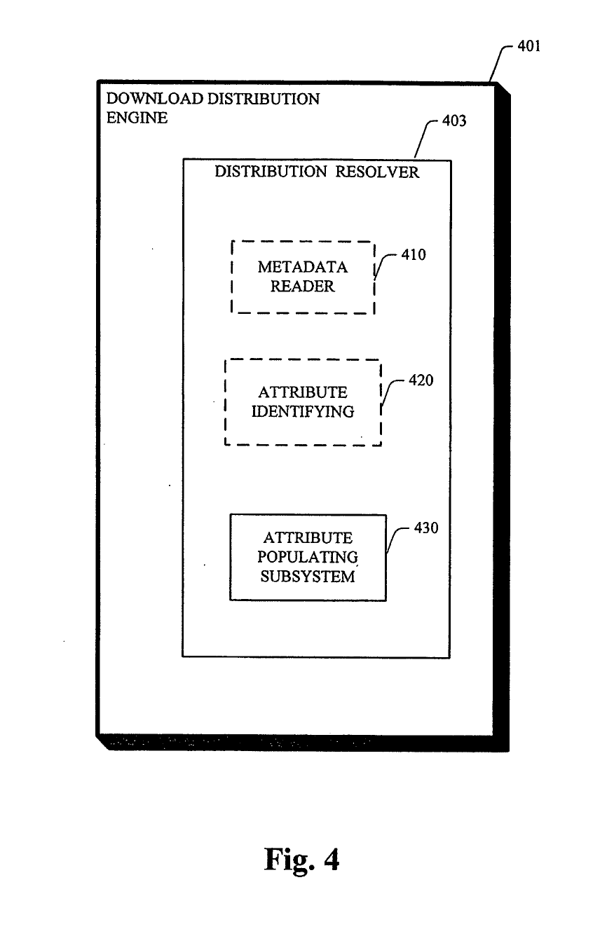

Turning now to FIG. 4, there is illustrated a detailed block diagram of a distribution resolver 403 that can supply information about the missing part of the downloaded software, and the ISV that such missing part should be obtained from. The distribution resolver 403 can include one or more subsystems (e.g., a metadata reader 410, an attribute identifying subsystem 420, an attribute populating subsystem 430) to facilitate download distribution capabilities provided by the download distribution engine 401. The metadata reader 410 can take as inputs one or more pieces of metadata associated with one or more missing objects and/or data types that are to be resolved. Such metadata can contain information including, for example, a list of attributes in a data type associated with the metadata (where the list includes attribute names, types, sizes, and the like), parameter types, parameter sizes, addresses and the like), and information identifying one or more classes that can be employed to interact with the data type if the entity with which an interaction is desired does not have the definition of the data type (e.g., a parent class) available.

In addition, data structures related to the missing portion of the software and objects or references can include: an array, a list, a heap, a stack, a table, a database record, a database table, a database and a data cube that can be employed in accordance with the subject invention. Accordingly, such information identifying one or more classes of the missing references and/or objects can be employed to interact with the data type and to determine where such can data can be obtained from. The metadata reader 410 can be operatively linked to the attribute identifying subsystem 420 and the attribute populating subsystem 430, to facilitate those subsystems identifying and/or comparing mismatched or missing objects and/or data types, to proper ISV source references.

In addition, once the distribution resolver 403, via the attribute identifying subsystem 420, has determined the missing portion of the references objects, then the attribute populating subsystem 430 can be employed to retrieve values and/or down load the missing objects from the proper ISV. Accordingly, in the component—based programming environments, the subject invention can facilitate distributed downloads from a plurality of ISV's, to enable a proper download and run of an application on a user's machine.

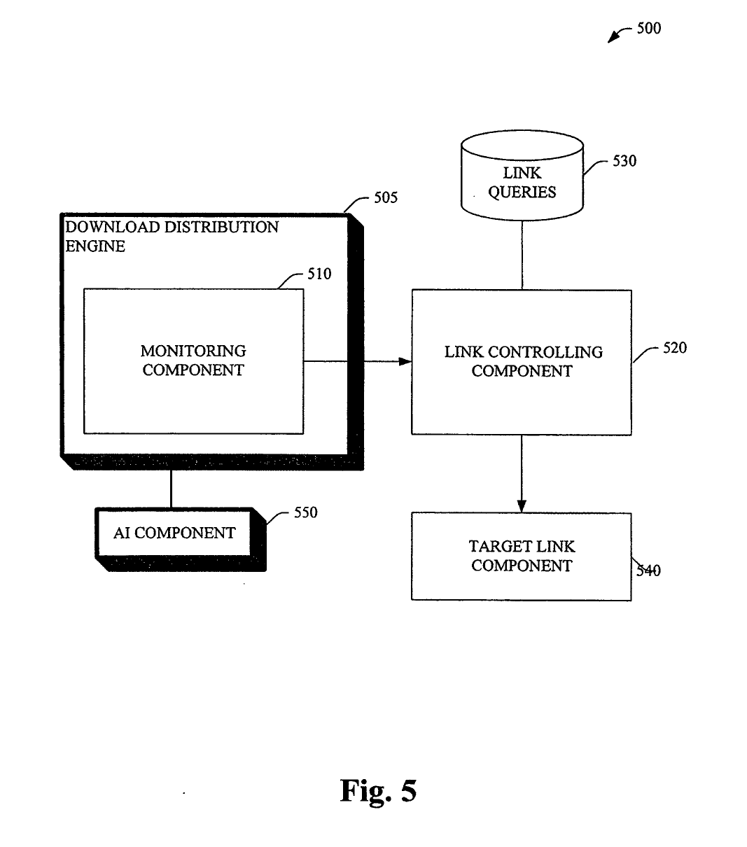

Referring now to FIG. 5, there is illustrated a general block diagram of a monitoring system 510 as part of the download distribution engine in accordance with a particular aspect of the subject invention. The monitoring system can actively observe the missing part of a downloaded application and/or objects and supply real-time hyperlinks to down load the missing portion from the proper ISV. As such, the monitoring component 510 can supply a respective target sites that corresponds to a web link of the proper ISV that can supply the missing portion of the downloaded software and/or digital content.

Accordingly, when a missing part of a downloaded software and/or object is encountered by the monitoring component 510, then information about such missing objects can be gathered or collected by and communicated to a link controlling component 520. The link controlling component 520 can examine the information communicated from the monitoring component 510 and compare it to the one or more stored link queries 530. The link queries 530 can comprise a plurality of different queries for a plurality of links (e.g., hyperlinks). For example, for any given link, at least one query can be set or programmed by a user. The query can include a set of conditions to be met or actions to be performed on the link when the condition(s) is satisfied. Each query can correspond to at least one hyperlink and the associated target site.

Moreover, when the monitoring component 510 has determined that a missing part of a downloaded software or digital content has been detected, it can also notify a user via a target link component 540 (e.g., browser). Examples of notification actions when detecting a missing reference and/or object can include changing the color of a hyperlink, modifying the title of the hyperlink to indicate that the content need to be accessed to resolve issues relating to the missing application, and/or adding a symbol to or removing a symbol from the hyperlink. Other types of notification actions are possible as well such as highlighting the hyperlink, drawing a line around the hyperlink, and/or adding some form of animation to the hyperlink (e.g., blinking text, fade-in/out text, etc.). The user can also receive an email or sound notification to alert it that a missing reference and/or component has been encountered. Moreover, the user can simply refer to the hyperlink monitor list to glance at the hyperlinks, to quickly ascertain whether a target website of a proper ISV needs to be contacted for successfully loading the missing portions of the downloaded program or digital content and/or objects.

Also, in connection with accessing a proper link and/or locating the required links for loading respective parts of a software or digital content form a respective ISV, the subject invention can employ various artificial intelligence schemes. For example, a process for learning explicitly or implicitly whether an object should be reloaded, or search for the website of an ISV that provides such object or missing references, can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class). As shown in FIG. 5, an artificial intelligence (AI) component 550 can be employed to facilitate inferring and/or determining when, where, how to locate the proper ISV for downloading a missing portion of the software and/or digital content. The AI component 550 can employ any of a variety of suitable AI-based schemes as described supra in connection with facilitating various aspects of the subject invention.

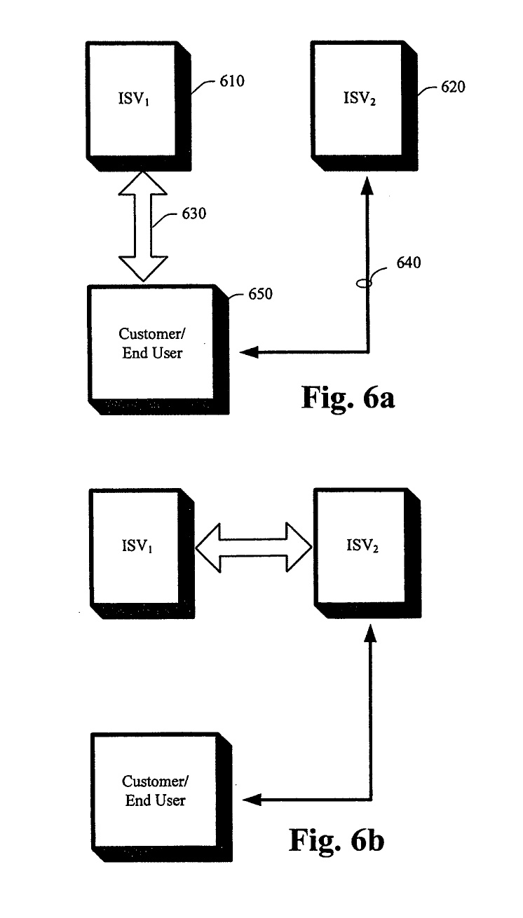

FIGS. 6a & 6b illustrate arrangements of a first ISV and a second ISV with respect to customers, and/or end user machines. As illustrated in arrangement of FIG. 6a, ISV₁ 610 and ISV₂ 620 can share a same level of customer control. For example, ISV₁ 610 can supply an application 630 to a customer/end user 650, which requires a Structured Query Language (SQL) 640 from the ISV₂ 620. Such ISV₂ 620 can supply the SQL component 640 required for a proper run of the downloaded application directly to customer 650. Likewise, an arrangement according to FIG. 6b provides a different degree of control by the ISVs over the client and distributed software.

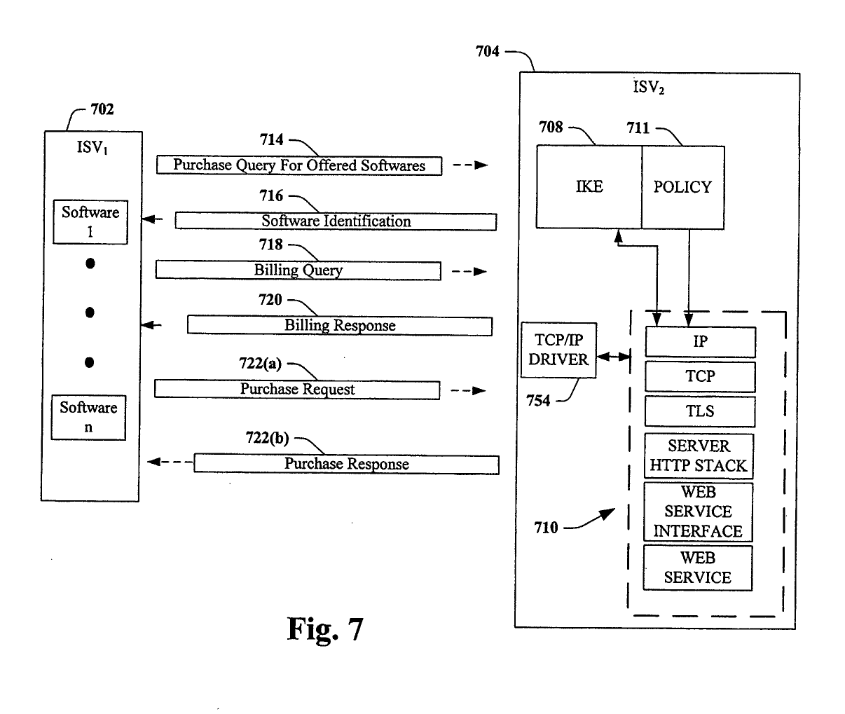

FIG. 7 illustrates a sequence of query steps between an ISV₁ 702 that offers software 1 thru m, where m is an integer, and an ISV₂ 704. The communication itself can be performed via a secure channel. ISV₂ 704 can include a service side secure network stack 710 that further includes an IP layer implementation, a service side TCP layer implementation, a service side TLS, an HTTP stack implementation, a web service provider interface and a web service. The ISV₂ 704 can further include an Internet Key Exchange (IKE) subsystem 708 for securing network traffic between the ISV₂ 704 and the ISV₁ 702. The ISV₂ 704 can also include policy modules 711 to enable configuration of the IKE subsystems 708. The policy module 711 can also provide security configuration information to the secure network stack 710, which communicate via TCP/IP driver 754, thereby enabling secure network traffic between the ISV₂ 704 and the ISV₁ 702.

The ISV₂ 704 can register and receive a set of messages for issuing a digital certificate to an entity. For example, at 714 a purchasing component can query the ISV₂ 704 for a purchase query of the various software offerings. Next, and at 716 a query response identifying the various software, and terms of the service is communicated back to the ISV₂ 704. Subsequently and at 718, a billing query is transferred to the ISV₂ 704. A response can then be prepared and sent back to the ISV₁ at 720 regarding various billing requirements for issuing a digital certificate.

Next, ISV₁ can select a desired plan for purchase, with a purchase request/response pair 722(a) & 722(b) exchanged between ISV₂ 704 and ISV₁ 702. Likewise, a set of queries and responses (not shown) can be exchanged between the ISV₂ 704 and the end user machine(s) to request updates to software and provide patches and the like. The purchase and update acts can also include a mechanism for the end user machines or the ISV₁ 702 to authenticate themselves with the ISV₂ 704.

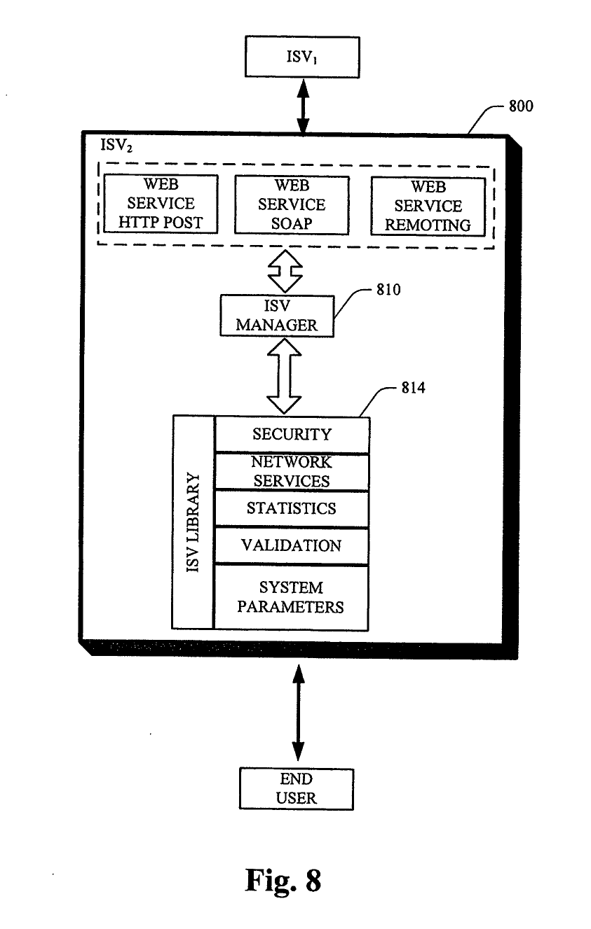

FIG. 8 illustrates a block diagram of an ISV₁ 800 system that can supply a download in accordance with an aspect of the subject invention. The system can include an ISV manger 810 that can interact with an ISV library 814, to track an authorization, security, validation and to verify connection of a client or another ISV₂ thereto. A load threshold can also be provided by the ISV manager 810, to determine whether to commence, pause, resume and/or halt data transfer on any machine that requests data exchange with the ISV₁ 800, for example, to balance processing across multiple machines, which can then mitigate burdening any one machine. Typically, when a message transfer session (e.g., a connection) is initiated, the ISV manager 810 can generate a connection instance for the session. The connection instance can be populated with information indicative of the client, the software download, other ISVs involved, message(s), and/or a connection ID (e.g., a keep-alive message), for example. Such information can be utilized to begin message transfer between the ISV₁ and a client or another ISV₂. Furthermore, the connection ID can be utilized to track message transmission within different machines.

The connection instance can additionally be dynamically updated to reflect transmission progress and provide transmission history. For example, indicia indicative of any portions—(including the entire message or software download)—that have been transmitted successfully or failed can be associated with the connection instance. Transmission history can include information related to transfer commencement and completion, pauses and resumes, the level of communication activity errors, re-submissions, changes in the servicing machine, and the like.

For example, when the ISV₁ 800 is invoked to establish a connection for a download to a client or end user, the ISV manager 810 can track machine identity (e.g., a globally unique identity, or GUID), to generate a connection instance for such connection. The connection instance can include the identity for any of the machines that the software is to be downloaded thereto, via the system parameters as part of the ISV library 814. Such information can be utilized to locate the desired machine and verify that the desired machine and adapter have been provided with access or been properly registered. If the invocation includes information indicative of the client and/or the message form other ISVs, such information can additionally be included with the connection instance. This information can be utilized to locate and verify the client and the downloaded software. In addition, the connection ID and required downloading parameters can be included and employed as a key to the connection instance, and also by the ISV manager 810 to manage the transfer session. It is to be appreciated that more than one machine on the ISV side, or on the client side can request connection, as part of a plurality of distributed machines. For example, during a downloading session between an ISV and an end user, another ISV can join the existing downloading session, and retrieve cached downloading history, to observe and/or engage in such downloading session.

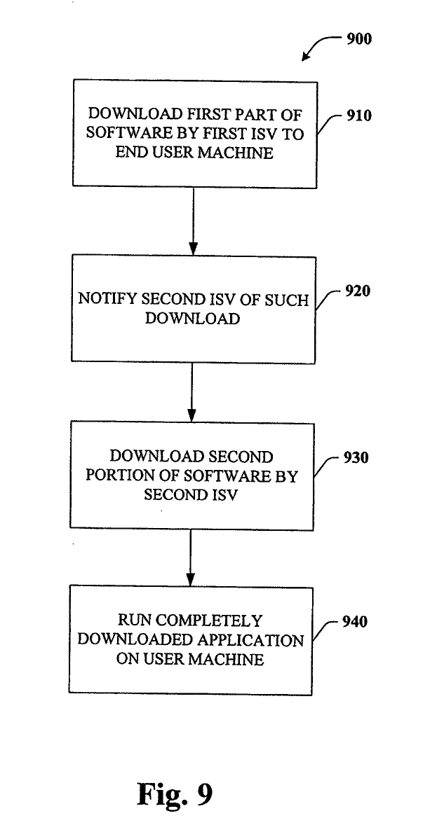

FIG. 9 illustrates a methodology 900 of a split download in accordance with an aspect of the subject invention. While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

Initially and at 910, a first portion of a software or digital content is being downloaded by a first ISV to an end user. Next, and at 920 a second ISV receives notification of such down load, and a request to supplement the first portion of downloaded software. Subsequently and at 930, the second ISV downloads the second portion of the ISV to the end user. As such, the end user can then properly run the downloaded application at 940, which has been downloaded in a split form by the first and second ISV.

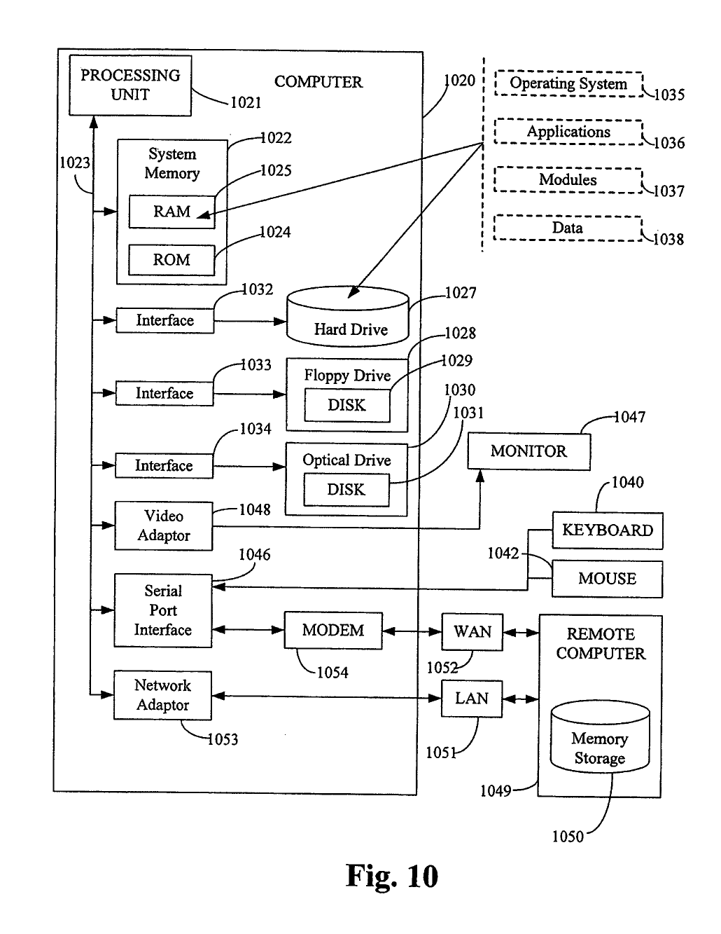

Referring now to FIG. 10, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 1020, including a processing unit 1021, a system memory 1022, and a system bus 1023 that couples various system components including the system memory to the processing unit 1021. The processing unit 1021 can be any of various commercially available processors. Dual microprocessors and other multi-processor architectures also can be used as the processing unit 1021.

The system bus can be any of several types of bus structure including a USB, 1394, a peripheral bus, and a local bus using any of a variety of commercially available bus architectures. The system memory may include read only memory (ROM) 1024 and random access memory (RAM) 1025. A basic input/output system (BIOS), containing the basic routines that help to transfer information between elements within the computer 1020, such as during start-up, is stored in ROM 1024.

The computer 1020 further includes a hard disk drive 1027, a magnetic disk drive 1028, e.g., to read from or write to a removable disk 1027, and an optical disk drive 1030, e.g., for reading from or writing to a CD-ROM disk 1031 or to read from or write to other optical media. The hard disk drive 1027, magnetic disk drive 1028, and optical disk drive 1030 are connected to the system bus 1023 by a hard disk drive interface 1032, a magnetic disk drive interface 1033, and an optical drive interface 1034, respectively. The drives and their associated computer-readable media provide nonvolatile storage of data, data structures, computer-executable instructions, etc. for the computer 1020. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention.

A number of program modules can be stored in the drives and RAM 1025, including an operating system 1035, one or more application programs 1036, other program modules 1037, and program data 1038. The operating system 1035 in the illustrated computer can be substantially any commercially available operating system.

A user can enter commands and information into the computer 1020 through a keyboard 1040 and a pointing device, such as a mouse 1042. Other input devices (not shown) can include a microphone, a joystick, a game pad, a satellite dish, a scanner, or the like. These and other input devices are often connected to the processing unit 1021 through a serial port interface 1046 that is coupled to the system bus, but may be connected by other interfaces, such as a parallel port, a game port or a universal serial bus (USB). A monitor 1047 or other type of display device is also connected to the system bus 1023 via an interface, such as a video adapter 1048. In addition to the monitor, computers typically include other peripheral output devices (not shown), such as speakers and printers.

The computer 1020 can operate in a networked environment using logical connections to one or more remote computers, such as a remote computer 1047. The remote computer 1047 may be a workstation, a server computer, a router, a peer device or other common network node, and typically includes many or all of the elements described relative to the computer 1020, although only a memory storage device 1050 is illustrated in FIG. 10. The logical connections depicted in FIG. 10 may include a local area network (LAN) 1051 and a wide area network (WAN) 1052. Such networking environments are commonplace in offices, enterprise-wide computer networks, Intranets and the Internet.

When employed in a LAN networking environment, the computer 1020 can be connected to the local network 1051 through a network interface or adapter 1053. When utilized in a WAN networking environment, the computer 1020 generally can include a modem 1054, and/or is connected to a communications server on the LAN, and/or has other means for establishing communications over the wide area network 1052, such as the Internet. The modem 1054, which can be internal or external, can be connected to the system bus 1023 via the serial port interface 1046. In a networked environment, program modules depicted relative to the computer 1020, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 1020, unless otherwise indicated. Such acts and operations are sometimes referred to as being computer-executed. It will be appreciated that the acts and symbolically represented operations include the manipulation by the processing unit 1021 of electrical signals representing data bits which causes a resulting transformation or reduction of the electrical signal representation, and the maintenance of data bits at memory locations in the memory system (including the system memory 1022, hard drive 1027, floppy disks 1028, and CD-ROM 1031) to thereby reconfigure or otherwise alter the computer system's operation, as well as other processing of signals. The memory locations wherein such data bits are maintained are physical locations that have particular electrical, magnetic, or optical properties corresponding to the data bits.

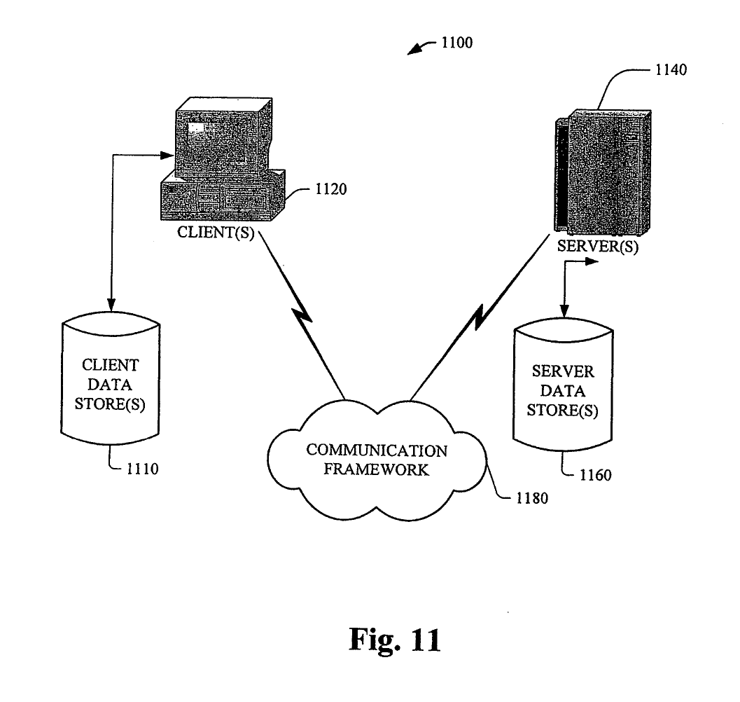

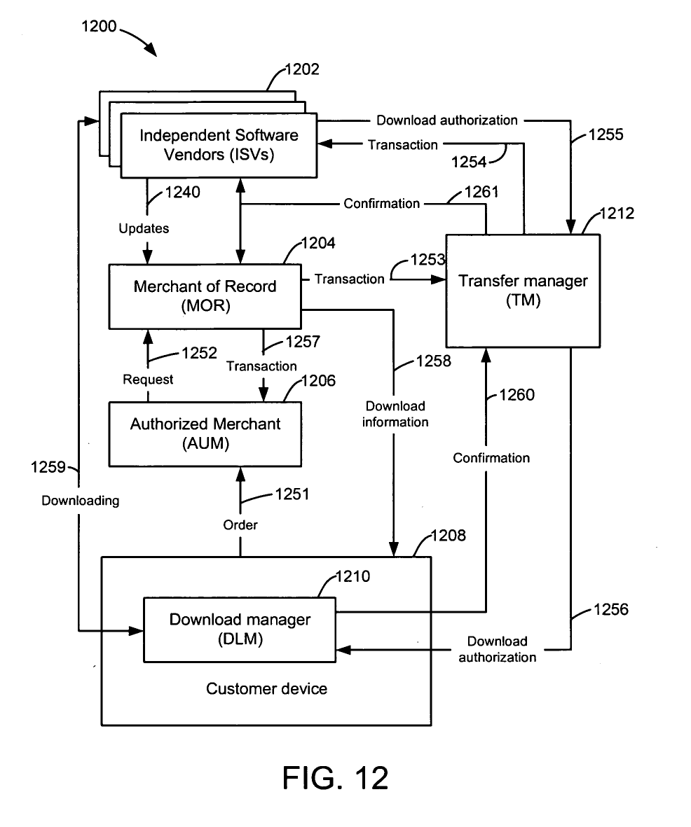

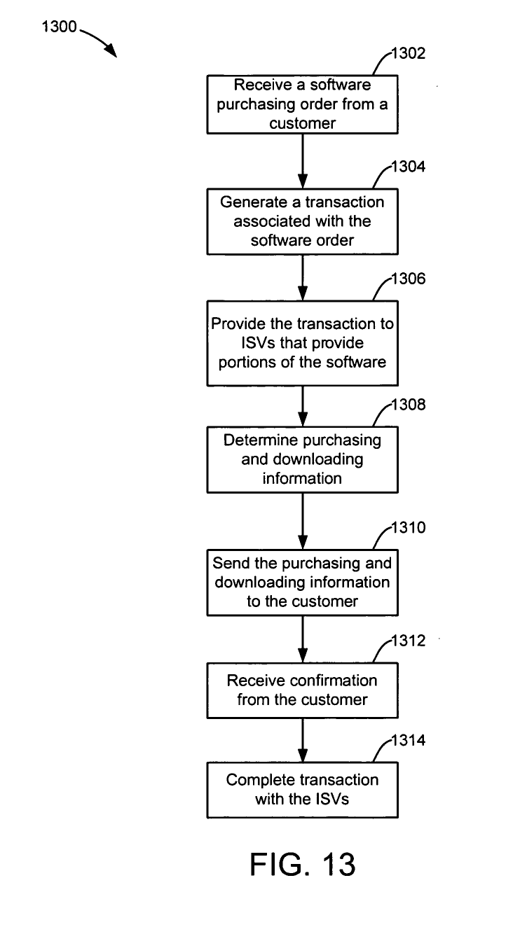

Referring now to FIG. 11, a client—server system 1100 that can employ a split download according to one aspect of the subject invention is illustrated. The client(s) 1120 can be hardware and/or software (e.g., threads, processes, computing devices). The system 1100 also includes one or more server(s) 1140. The server(s) 1140 can also be hardware and/or software (e.g., threads, processes, computing devices). For example, such servers 1140 can house threads to perform transformations by employing the present invention. The client 1120 and the server 1140 can communicate, in the form of data packets transmitted according to the present invention, between two or more computer processes. As illustrated, the system 1100 includes a communication framework 1180 that can facilitate communications between the client(s) 1120 and the server(s) 1140. The client(s) 1120 is operationally connected to one or more client data store(s) 1110 that can store information local to the client(s) 1120. Moreover, client 1120 can access and update databases 1160 located on a server computer 1140 running a server process. In one aspect of the present invention, the communication frame work 1180 can be the internet, with the client process being a Web browser and the server process being a Web server. As such, a typical client 1120 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 1140 can be university or corporate mainframe computers, or dedicated workstations, and the like.

FIG. 12 shows an example system 1200 for purchasing and distributing software using split download. System 1200 includes multiple ISVs 1202 that are configured to provide software to customers, such as customer device 1208. Each ISV is configured to provide portion of software. Portions provided by the different ISVs are downloaded and are then used to build the complete software. For example, customer device 1208 may include download manager (DLM) 1210 for managing the downloading of the portions of the software.

As shown in FIG. 12, system 1200 also includes merchant of record (MOR) 1204, transfer manager (TM) 1212, and authorized merchant (AUM) 1206. MOR 1204 is the merchant responsible for managing and supporting the sale of software provided by ISVs 1202. MOR 1204 may be configured to handle transaction support, returns, paying ISVs 1202, or the like. For example, MOR 1204 is configured to receive requests from customer device 1208 for purchasing software and to generate a transaction for the purchase. MOR 1204 is also configured to receive record updates from ISVs 1202. The updates may include periodic transaction query, billing information, and the like. TM 1212 is configured to control file transfer request and authorization and to broker data transfer and billing information between MOR 1204 and ISVs 1202. AUM 1206 is an agent acting on behalf of MOR 1204. AUM 1206 may take on any of the roles of MOR 1204, except as the agent of ISVs 1202. AUM is an optional component and MOR 1204 can directly interact with customer device 1208.

In an example software purchasing scenario, customer device 1208 sends message 1251 to AUM 1206 that includes an order for a particular piece of software. The order may include an identifier for the software, quantity, credit card information, personal information, and the like. AUM 1206 receives the order and sends message 1252 to MOR 1204 that includes a request associated with the order. The request may include an identifier for the customer, an identifier for the request, a geographic location, the order, and the like. MOR 1204 receives the request and generates a transaction associated with the request. MOR 1204 sends the transaction to TM 1212 with message 1253. Message 1253 may include information in the original request as well as other information, such as an identifier for MOR 1204, a transaction identifier, a serial number, data associated with the customer, status information, and the like. MOR 1204 sends message 1257 to AUM 1206 that includes information related to the transaction to AUM 1206.

TM 1212 receives the transaction from MOR 1204 and sends messages 1254 with the transaction to the appropriate ISVs 1202. Typically, TM 1212 sends the transaction to the specific ISVs that provide portions for the software being purchased. In response, the specific ISVs send messages 1255 that include downloading authorization and related information to TM 1212, which may include an ISV identifier, a key, authorization data, and the like. TM 1212 receives the message 1255 and sends the downloading authorization and related information to DLM 1210 in message 1256. MOR 1204 sends message 1258 to customer device 1208 that includes information about the order, such as a purchase record, downloading location, license for the software, and the like. Message 1258 may be sent as any type of communication, such as email, s-mail, etc. DLM 1201 establishes communications 1259 with ISVs 1202 for downloading the purchase software from the ISVs that provide portions of the software. DLM 1201 provides the downloading authorization received from message 1256 to the ISVs to establish that the customer is authorization to download the software.

After the downloading has been completed, DLM 1210 sends message 1260 that includes a confirmation to TM 1212. TM 1212 sends messages 1261 to ISVs 1202 and MOR 1204 to confirm the downloading and to complete the transaction.

FIG. 13 shows an example process 1300 for processing an order for software to be provided by split download. Process 1300 may be implemented by a merchant of record for a split download software purchasing system to process an order for software. At block 1302, a purchasing order is received from a customer. The order may be received directly from the customer's device or from an authorized merchant. At block 1304, a transaction associated with the software order is generated. At block 1306, the transaction is sent to the independent software vendors that provide portions of the software. At block 1308, purchasing and downloading information for the software is determined. At block 1310, the purchasing and downloading information is provided to the customer. For example, the information may be provided to the customer by email. Typically, downloading authorization is provided to the customer from a separate source, without going through the merchant of record. At block 1312, confirmation is received from the customer after the software has been downloaded from the ISVs. At block 1314, the transaction is completed with the ISVs.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”)

What is claimed is:

1. A system that facilitates a split download of a digital content comprising:
a download distribution engine that provides information about a missing portion of a downloaded digital content, to an independent software vendor (ISV), and
a supplemental digital content supplied by the independent software vendor to complete the downloaded digital content.

2. The system of claim 1, the download distribution engine includes a detector component that detects the missing portion.

3. The system of claim 1, the download distribution engine further comprises a notification component that notifies a user where to down load the missing portion or obtain additional information about resolving problems associated with the missing portion.

4. The system of claim 1, the download distribution engine further comprises a monitor component that provides a process to install the missing portion.

5. The system of claim 4, the monitor component supplies real-time hyper links to down load the missing portion from the ISV.

6. The system of claim 1, the download distribution engine further comprises a distribution resolver that determines an availability of the missing portion for a download.

7. The system of claim 6, the distribution resolver further comprises a metadata reader component to obtain information about the missing portion.

8. A method of split downloading a digital content comprising:
downloading a first portion of the digital content by a first ISV; and
supplying information regarding the downloading act to a second ISV.

9. The method of claim 8 further comprising initiating the act of downloading the first portion of the digital content by an end user.

10. A system that facilitates a split download of a digital content comprising:
means for providing information about a missing portion of a downloaded digital content, to an ISV; and
means for supplementing the digital content.

11. A computing device for providing downloadable software, the computing device being configured to interact with a plurality of independent software vendors (ISVs), each ISV configured to provided a portion of the downloadable software, the computing device also configured to receive an order to purchase the downloadable software from a client device and to generate a transaction associated with the order, the computing device further configured to provide the transaction to the ISVs and to provide information to the client device for downloading portions of the software from the ISVs.

12. The computing device as recited in claim 11, wherein each portion of the downloadable software is provided by a separate ISV and all of the portions are necessary to build the complete software by the client device.

13. The computing device as recited in claim 11, wherein the client device is configured to interact with the computing device through an authorized merchant.

14. A system for purchasing and distributing software comprising:
a plurality of independent software vendors (ISVs), each ISV configured to provided a portion of downloadable software, each portion of the downloadable software being provided by a separate ISV;
a merchant of record configured to handle an order for the downloadable software from a customer, the merchant of record also configured to generate a transaction associated with the order and to provide the order to the ISVs;
a download manager associated with the customer, the download manager being configured to download portions of the software from the ISVs and to build the complete software from the downloaded portions.

15. The system as recited in claim 14, further comprising a transfer manager configured to provide the transaction generated by the merchant of record to the ISVs, the transfer manager also configured to receive download authorization from the ISVs and to provide the download authorization to the customer for use with downloading portions of the software from the ISVs.

16. The system as recited in claim 14, wherein all of the portions are necessary to build the complete software by the download manager.

17. The system as recited in claim 14, further comprising an authorized merchant configured to act as an agent for the merchant of record for processing the order from the customer.

18. One or more device-readable medium encoded with device-executable instructions:
receiving an order from a customer for purchasing a downloadable software;
generating a transaction associated with the order;
identifying a plurality of ISVs, each providing a portion of the software in the order, all of the portions being necessary to build the complete software;
providing the transaction to the ISVs;
determining purchasing and downloading information associated with the transaction; and
sending the purchasing and downloading information to the customer.

19. The one or more device-readable medium as recited in claim 18, wherein the order is received from the customer through an authorized merchant.

20. The one or more device-readable medium as recited in claim 18, wherein the transaction is provided to the ISVs through a transfer manager.
